(19) United States
(12) Patent Application Publication
(10) Pub. No.: US 2004/0062023 A1
(43) Pub. Date: Apr. 1, 2004

(54) Fibre optic light system for hydroponics

(76) Inventor: Christopher Elsegood, Hamilton, CA (US)

Correspondence Address: DOWELL & DOWELL PC, SUITE 309, 1215 JEFFERSON DAVIS HIGHWAY, ARLINGTON, VA, 22202

(21) Appl. No.: 10/398,125

(22) PCT Filed: Oct. 3, 2001
(86) PCT No.: PCT/CA01/01386

(51) Int. Cl. F21V 33/00

(52) U.S. Cl. 362/2; 362/554; 362/583; 362/253

(57) ABSTRACT

There is provided in accordance with the present invention a lighting system comprising a light source providing optimal spectral characteristics for plant growth, a means for focusing light from said light source into a fibre optic transmission medium, a fibre optic cable for transmitting light from said remote light source to a light distribution means, and a light distribution means, to distribute light over a specified area above the plants.

### FIELD OF THE INVENTION

This invention relates to a complete fibre optic lighting system for hydroponics or indoor nurseries. The system can be used in small home settings, or in large commercial greenhouses, or in biofiltration. Use of fibre optic allows the light source and its attendant heat to be located remotely from the plant growth area. This provides for consistent growing temperatures and reduced need for specialized cooling systems both in the area of the bulb and a reduced need for generalized cooling (air conditioning) in the contained growing area.

### BACKGROUND OF THE INVENTION

With indoor growing, light, temperature, air, ventilation, humidity, CO2, water and nutrients can be precisely controlled to create the perfect environment for plant growth. Of these elements light is by far the most important. Natural light is the optimum light for all stages of plant growth however in many areas the amount of natural light available must be supplemented with artificial light to maximize plant production.

Natural light and artificial lights have different spectrums. There are many different types of artificial light depending on the light source used and each light source has its own unique spectral characteristics. The spectral characteristics can be altered or enhanced by the use of filters, coatings on reflecting units and other means. Normally the blue-violet and the red-orange segments of the visible light spectrum are the most important for photosynthesis and chlorophyll production. Predominantly red-orange light encourages flowering and stem elongation, while blue-violet light produces plants which are short and bushy.

A variety of lighting systems for indoor plant growth are currently in use. In almost all cases the high amount of light output required also results in considerable heat being generated near the light source. As prior art systems require that the light source be placed close to the plants, a significant temperature gradient develops in the air near the plants, which can produce inconsistent growing results. Light sources that have been used in the past include flourescent lighting, high and low pressure sodium lights, metal halide lighting and a variety of others.

Often times water-cooled lighting systems must be used to deal with the excessive heat produced by such bulb technologies. Water-cooled lighting systems allow the placing of many light sources close to each other with very little heat build-up. This allows the light intensities to get very high ensuring that maximum rate of photosynthesis occurs on all leaves on any given plant. Water jackets are one of the most common cooling systems used. The water jacket surrounds the bulb and absorbs a very high percentage of the infrared heat coming from the bulb. Unfortunately, the water jacket also has the negative result of absorbing up to 20% of light output.

Air-cooled systems are also employed. In essence, the air around the bulb is contained in some type of enclosure which is vented and in which air flow is created. Typically, cooling fans and motors are used to exhaust the warm air away from the plants.

There are many disadvantages of the current systems in addition to the heat output, including complexity, cost, and difficulty of maintenance and operation. Of these, having the heat output close to the plants is the most problematic.

The present invention seeks to improve on existing lighting systems for hydroponics and indoor plant growth by providing the ability to locate the light source, and thus the attendant heat generated, remotely from the plant growing area. This is accomplished by using fibre optic light transmission systems which transmit specialized light produced from projection-type bulbs, through standard fibre optic cabling to the plant growing areas. The use of fibre optic cable to transmit the light allows the system to locate the light source remotely from the plants. In some cases the system design may even allow the light source to be located outside the greenhouse or indoor growing area. In these cases the heat generated inside the growing area is vastly reduced compared to prior lighting systems, in some cases being virtually negligible.

One major advantage in such systems is consistent growing temperatures inside the growing area. Another major advantage is the reduced requirement to deal with the heat via complicated and expensive water or air cooling systems. These systems are difficult and expensive to maintain and can fail. One further advantage relates to the ambient temperature of the indoor growing area. In traditional systems the heat is generated inside the greenhouse or growing area resulting in the necessity for air conditioning to keep the temperature within normal limits. The cost of air conditioning can be a significant operating cost for greenhouse operators and other plant growers.

### OBJECTS OF THE INVENTION

It is an object of the invention to provide an improved lighting system for hydroponics and indoor plant growth in general.

It is a further object of the invention to provide a lighting system using fibre optics to allow flexibility in location of the light source for the lighting system.

It is a further object of the invention to provide a lighting system that is capable of locating the light source outside an indoor growing area.

It is a further object of the invention to provide a lighting system with more consistent growing temperatures.

It is a further object of the invention to provide a lighting system without the need for complicated water or air-based cooling systems to reduce localized heat.

It is a further object of the invention to provide a cost efficient integrated lighting system, for hydroponics and indoor plant growth which is generally improved.

Thus there is provided in accordance with the present invention a lighting system comprising a light source providing optimal spectral characteristics for plant growth, a means for focusing light from said light source into a fibre optic transmission medium, a fibre optic cable for transmitting light from said remote light source to a light distribution means, and a light distribution means, to distribute light over a specified area above the plants.

### BRIEF DESCRIPTION OF THE DRAWINGS

The apparatus of the invention will now be described with reference to the accompanying drawings, in which:

FIG. 1 is a perspective view showing the fibre optic troffer of the present invention;

FIG. 2 is a perspective view of the light source of the present invention including the power source, the bulb enclosure, cooling fan and connections for fibre optic cable;

FIG. 3 is a sketch depicting a sectional view of the light source of the present invention showing the power source, the projection bulb, the reflector and provision for airflow through the unit;

FIG. 4A is a side view of an incandescent projection bulb which can be used in the present system;

FIG. 4B is an end view of an incandescent projection bulb and accompanying reflector unit;

FIG. 5A is a side view of a sodium projection bulb which can be used in the present system;

FIG. 5B is an end view of a sodium projection bulb and accompanying reflector unit;

FIG. 6A is a side view of a metal halide projection bulb which can be used in the present system; and

FIG. 6B is an end view of a metal halide projection bulb and accompanying reflector unit.

### DETAILED DESCRIPTION OF THE INVENTION

In order to more clearly understand the present invention part numbers as assigned in the following parts list will be used:

| Part Number | Description |
|---|---|
| 2 | Fan Grill |
| 4 | Cool Air Flow |
| 6 | Reflector |
| 8 | Power input |
| 10 | Fibre head |
| 12 | Optical Port for Fibre head |
| 14 | Fan optic cable |
| 16 | Fan for fibre port |
| 18 | Transformer |
| 20 | Exhaust fan |
| 22 | Hot air outlet |
| 24 | Specialty projection bulb |
| 26 | Power source enclosure |

The lighting system comprises an improved light source for illuminating optical fibres including a high intensity gas discharge lamp positioned within a reflector assembly that focuses radiation from the lamp unto a remote focal point, and that selectively transmits and reflects desired visible radiation and attentuates undesirable ultraviolet and infrared radiation. The alignment procedures and the geometry of the reflector itself ensure maximization of flux intensity is supplied to the optical fibres positioned at the remote focal point of the reflector assembly. An optical coupling is used to retain the fibres together and hold them in proper alignment.

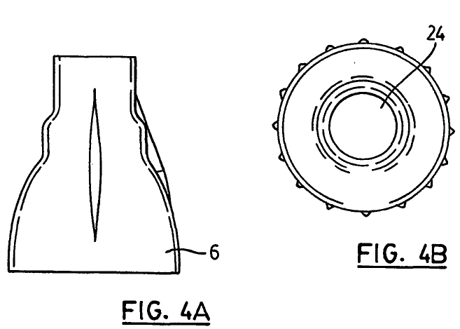

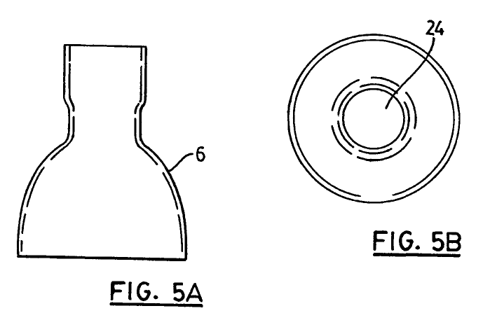

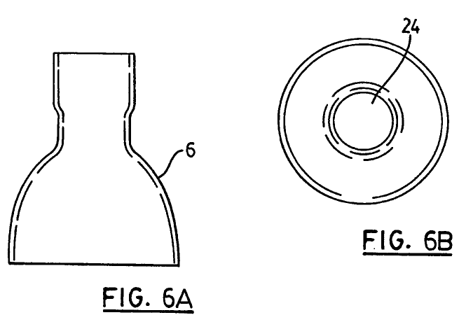

More specifically and referring to FIGS. 4A, 4B, 5A, 5B, 6A and 6B there is shown a variety of projection lamps, including bulbs, having pairs of electrodes. (Note sulfur bulbs not shown—do not have electordes). The bulbs may contain an ionizable gas (or gases) and the vapors of such metals as tin, thallium and mercury. The bulbs are formed in a glass blank that rigidly supports the electrodes and the lead-in conductors for the electrodes, in fixed relation. The bulb and blank and lean-in conductors are housed within a glass shell that is attached to the base through which the lean-in conductors pass to form connector pins. Lamps of this type are currently of limited commercial availability having the specialized spectrums required to optimize plant growth.

The lamps typically include a reflector substantially axially and symmetrically disposed about the lamp. The lamp may be symmetrically orientated about the horizontal and vertical axis for the purposes of correlating the illumination intensity of the lamp.

The reflector housing includes a reflector section, an alignment section and a mounting section. The reflector section is designed to focus the light that is emitted from the filament of a gas-discharge arc which is maintained between electrodes by conventional external circuitry. The light is focused in a relatively small focal area at which the ends of one or more optical fibres are located.

The reflector section is formed generally as a truncated, regular ellipsoidal shape of revolution about the origin axis, on which lay the foci of the ellipsoidal shape. The ellipsoidally-shaped reflector section may extend further than the location of the plane in the direction toward the focal point in order to capture and reflect additional flux emitted from the electrodes. The specific shape of the ellipsoidal reflector section can be altered and optimized for different bulb types.

In some cases reflectors or reflective properties are built directly into the bulb such as in projection bulbs.

Different bulb types are commonly used during different growth stages of plants. At certain times incandescent lamps provide an optimum spectrum of light, having a higher percentage of light in the red area of the spectrum. Sodium bulbs are used to optimize growth during other stages of plant growth while plant growth using metal halide bulbs is preferred at other stages of plant growth. Typically high pressure sodium lights have the highest theorectical efficiency providing up to 140 lumens per watt. Metal halide bulbs and super metal halide bulbs provide between 100 and 125 lumens per watt and are also extremely efficient. Incandescent lights are the least efficient of bulbs typically used for plant growth providing somewhere in the range of 15 to 20 lumens per watt on average.

Metal halide, or multi-vapor, high intensity discharge lamps provide one of the most complete spectrums for plant growth in the absence of natural light. Metal halide lamps produce a reasonable amount of light energy in the blue-violet and red-orange ends of the spectrum. Metal halide bulbs are typically used for both the vegetative and the flowering stages of plant growth. What is typically deficient in metal halide lighting systems is energy in the red end of the spectrum. This often has to be supplemented for optimum seed germination, vegetative growth and flowering. High pressure sodium (HPS) bulbs produce light energy biased towards the red-orange wave lengths. HPS systems generally do not provide the necessary blue end of the spectrum required for vegetative growth. HPS bulbs may be used for all stages of plant growth but are often limited to use during flower initiation and development periods. HPS bulbs may be manufactured with augmented blue light which makes them more suitable for all growing periods.

Newer sulfur lamps may also be used. A sulfur lamp is an electrodeless lamp that includes an evacuated quartz bulb partly backfilled with argon and with a little sulfur, plus a source of microwave power for exciting a plasma within the bulb. A sulfur lamp is very efficient for visible lighting. An attempt to increase the emission of red light by increasing the sulfur content would result in an excessive reduction in the emission of blue light. Alternatively, following a common practice in the lighting industry, one could attempt to increase the red emission by adding such metal halides as sodium iodide: in the presence of the lamp plasma, the metal atoms in most such additives become excited and ionized and they radiate in the desired spectral region, but they also emit unwanted infrared line radiation, with a consequent reduction in efficacy for growth of plants.

Calcium bromide can be added to the sulfur filling in a sulfur lamp to increase the emission of red light for enhanced growth of plants. Red light is more efficacious for plant growth than is visible light at shorter wavelengths. The addition of calcium bromide increases the emission at wavelengths in the vicinity of 625 nm, where the quantum efficiency for photosynthesis is close to 1.

Unlike other metal halide additives, in the presence of the lamp plasma, calcium bromide emits primarily molecular radiation at wavelengths in the vicinity of 625 nm, with minimal infrared emission. Thus, calcium bromide can be used to increase the emission of the desired red light. A representative experimental lamp based on this concept is made of a thin-wall, 35-mm-diameter quartz bulb containing tens of milligrams of sulfur,a few milligrams of calcium bromide, and argon at a pressure of about 50 too (6.7 kPAa). The calcium bromide filling increases the desired red emission at the cost of only a small decrease in shorter-wavelength emission and with little or no increase in infrared emission.

The spectrums of many bulbs may also be altered somewhat by the specialized reflective coatings placed on the inside of the corresponding reflector housing. One or more coatings may be used to “shift” a bulb's natural spectrum which is dictated by the material contained inside the arc tube. In some cases multiple coatings can optimize spectrums very near to that provided by natural light.

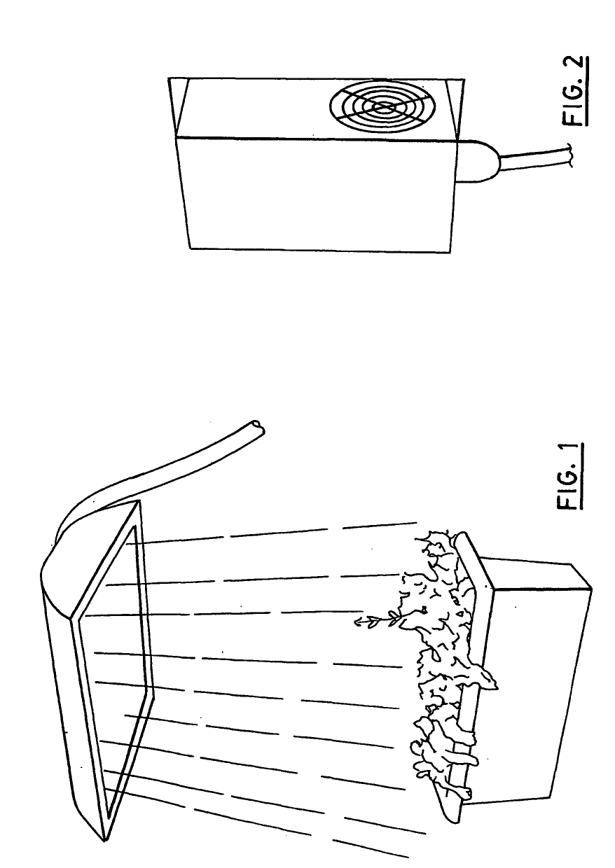

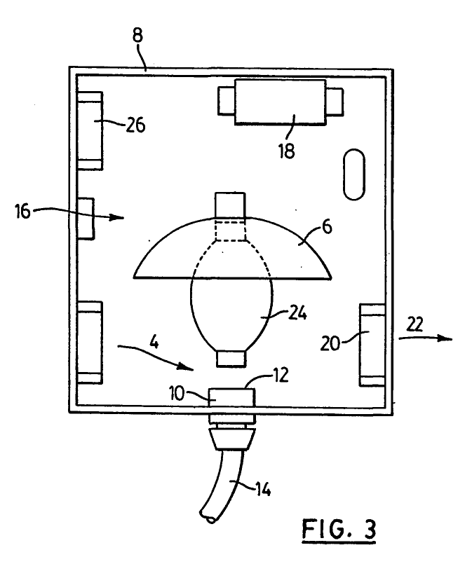

In the present invention the transmission means for transmitting light from the light source to the growing area is preferably fibre optic cable. This is shown in FIGS. 1 and 2. By fibre optic cable it is meant a plurality of optical fibres bunched together. There may be for example, several hundred individual fibres in such a cable. Such cables have the advantage over single fibres of fibre redundancy in case of breakage and the presentation of a larger area of fibre ends to the light source.

The fibre optic cable or bundle is terminated at the light source end by grouping the fibres together and polishing their end faces. Ideally the location of the end faces is at the focal point, or in the small focal area, generated by the light source.

The fibre optic cable is terminated at the plant end into a light distribution means. The light distribution means can include standard diffusers, couplings, lens or possibly even the bare ends of the fibres.

In one embodiment, the light distribution means can be a light troffer similarly-shaped to that used with conventional indoor growing lighting systems, and resembling a standard 2 foot by 4 foot reflector unit. These units are used in all types or residential and commercial construction for flourescent lights. While resembling standard light reflecting units the fibre optic troffer is constructed completely differently. Each fibre end must be located and aligned to optimize the direction of light transmission exiting through the fibre ends.

One method of achieving such alignm nt to provide even light distribution is to affix each individual fibre into a grid of suitable material such as lucite or plexiglass with a variety of holes provided therein. The individual fibres may be held in place with a friction fit or with the additional permanence of some glue or potting compound to restrict fibre movement. Normally each fibre would be separated from the main bundle and placed in the individual hole or another suitable locating means so that the fibres that comprise the cable are located in generally parallel and equal-shaped alignment. The fibre ends would be orientated in generally the same direction thus providing for optimum transmission and direction of light output from the ends of the fibres.

As the “troffer” unit would not function as a reflector it would be possible for the troffer housing, or upper section of the troffer, to be made from transparent material to permit a maximum amount of natural light to pass there through. A choice of materials for the locating grid inside the troffer unit, the troffer housing, etc. may be made solely based on the characteristics of the ability to machine said materials for the purposes of easily locating and affixing the individual fibres in the spaced-relation described above. Materials may be lightweight and low cost thus reducing the overall cost of the system and allowing adjustment of the light troffer units easily by users.

It will be understood that modifications can be made in the embodiments of the invention described herein.

1. A light for illuminating plants, adapted to be attached to a power source, comprising:
a light source attached to the power source and being located remotely from the plants;
a plurality of elongate fibre optic wave guides each having a first end proximate to the light source and a second distal end proximate to the plants.

2. A light as claimed in claim 1, wherein the light source is optimized for the blue-violet end of the visible light spectrum.

3. A light as claimed in claim 1, wherein the light source is optimized for the red-orange end of the visible light spectrum.

4. A light as claimed in claim 1, wherein the light source is optimized over the complete visible light spectrum so as to emulate natural sunlight.

5. A light as claimed in claim 1, wherein the light source is a high intensity gas discharge bulb.

6. A light as claimed in claim 1, wherein the light source is a sodium bulb.

7. A light as claimed in claim 1, wherein the light source is a sulfur bulb.

8. A light as claimed in claim 7, further comprising a metal halide additive which is introduced into the sulfur bulb.

9. A light as claimed in claim 8, wherein the metal halide additive is calcium bromide.

10. A light as claimed in claim 1, wherein the light source is a projection bulb.

11. A light as claimed in claim 1, wherein the light source further comprises an external parabolic reflector to focus light at a focal point.

12. A light as claimed in claim 1, wherein the light source is enclosed in an integrated housing including the power supply and a cooling system.

13. A lighting system for illuminating plants comprising:
a power source;
a light source attached to the power source and being located remotely from the plants;
a plurality of elongate fibre optic wave guides each having a first end proximate to the light source and a second distal end proximate to the plants;
a distribution means for diffusing the light over the plants.

14. A lighting system as claimed in claim 13, wherein the distribution means is a lighting troffer.

15. A lighting system as claimed in claim 13, wherein the distribution means is a diffuser.

16. A lighting system as claimed in claim 13, wherein the distribution system is a lens.

17. A method for illuminating plants comprising:
providing power from a power source to excite a light source;
locating the light source in close proximity to the power source;
locating the light source and power source remotely from the plants;
transmitting light from the light source to the plants via a plurality of elongate fibre optic wave guides each having a first end proximate to the light source and a second distal end proximate to the plants;
distributing the light transmitted via the wave guides over the plants.

18. A method as claimed in claim 17, wherein the light is distributed via a lighting troffer.

19. A method as claimed in claim 17, wh rein the light is distributed via a diffuser.

20. A method as claimed in claim 17, wherein the light source is a high intensity gas discharge bulb.

21. A method as claimed in claim 17, wherein the high intensity discharge bulb is one of the group of a sodium, sulfur or metal halide.
